(19) United States
(12) Patent Application Publication
(10) Pub. No.: US 2008/0069764 A1
(43) Pub. Date: Mar. 20, 2008

(54) Process for making pigmentary titanium dioxide

(75) Inventors: Harry E. Flynn, Edmond, OK (US); Charles A. Natalie, Edmond, OK (US); Robert O. Martin, Edmond, OK (US)

Correspondence Address: William B. Miller, P. O. Box 268859, Oklahoma City, OK, 73126-8859, US

(73) Assignee: Tronox LLC

(21) Appl. No.: 11/522,702

(22) Filed: Sep. 18, 2006

(51) Int. Cl. C01G 23/047

(52) U.S. Cl. 423/613; 23/294 R

(57) ABSTRACT

A process is disclosed for making pigmentary titanium dioxide through the oxidation of titanium tetrachloride in the presence of aluminum chloride, in which aluminum chloride solids are sublimed and combined with titanium tetrachloride gases and the combination oxidized in an oxidizer. Also, a process and apparatus for subliming aluminum chloride solids at least in part by conductive heat transfer from inert, thermally conductive solids in a fluidized bed.

### FIELD OF THE INVENTION

This invention generally relates to the making of pigmentary titanium dioxide by a chloride process, and more particularly, to the making of chloride process titanium dioxide pigments via the oxidation of titanium tetrachloride, in which aluminum chloride (AlCl₃) is employed in the oxidation step as a rutilization aid and to impart durability to the titanium dioxide pigments.

### BACKGROUND OF THE INVENTION

In the well-known manufacture of pigmentary titanium dioxide by oxidation of a gaseous stream of titanium tetrachloride, certain properties of the titanium dioxide are much enhanced when the titanium tetrachloride reactant stream is augmented with a small amount (depending on the pigment manufacturer, typically ranging from 0.5 up to 10 percent by weight, though more preferably being from about 1 to about 5 and especially from about 1 to about 2 weight percent) of an aluminum salt, especially aluminum chloride. Other metal chlorides, for example, zirconium, silicon and phosphorus, produce some similar and some additional effects and improvements and so have been added or suggested for addition to the titanium tetrachloride reactant stream as well. Aluminum chloride, however, is most commonly used for its relatively lower cost.

In practical terms, the use of at least one or more additional metal chlorides, such as the just-mentioned aluminum chloride, is always commercially necessary for achieving the desired degree of rutilization in the crude titanium dioxide product issuing from the oxidizer, as well as for influencing the pigment's particle size and durability.

Various methods and apparatus have been used or suggested for use over the years for adding in aluminum chloride to a chloride process for oxidizing titanium tetrachloride to produce a crude, chloride process pigmentary titanium dioxide.

One known method has involved the dissolution of (conventionally purchased) aluminum chloride solids in hot liquid titanium tetrachloride, followed by vaporization of the mixture and addition of the same to the oxidizer. As described in U.S. Pat. No. 2,824,050, this method has been used as an alternative to forming separate aluminum chloride and titanium tetrachloride gaseous streams and then combining the separate gaseous streams. Precise control of the composition of the gaseous mixture proved to be a problem, however, whereas the dissolution of aluminum chloride solids in hot liquid titanium tetrachloride was said to enable controlled amounts of the additive to be used.

Unfortunately, this method of adding in aluminum chloride to the process (that is, by dissolution of aluminum chloride solids into hot liquid titanium tetrachloride) has its own drawbacks, a principal drawback being that commercial aluminum chloride solids contain impurities which react with the titanium tetrachloride and produce deposits in the apparatus used eventually for vaporizing the titanium tetrachloride/aluminum trichloride mixture. Further, dissolution of the solid aluminum chloride does add some time to the overall production cycle time, and the mixture of aluminum chloride and titanium tetrachloride is corrosive to the extent whereby equipment exposed to the mixture—for example, the vessel(s) in which the aluminum chloride and titanium tetrachloride are mixed and the aluminum chloride solids dissolved into the hot liquid titanium tetrachloride, the piping to apparatus for vaporizing the mixture and the vaporization apparatus itself—are generally specially lined with a corrosion-resistant material such as with a glass liner, or else must be constructed of a costly, corrosion resistant high nickel alloy, for example.

It has also been known, as mentioned above in passing, to generate an aluminum chloride gaseous stream onsite in a so-called “aluminum chloride generator”, as a generally more economic alternative to the purchase of aluminum chloride solids as produced for the manufacture of aluminum metal and related products.

U.S. Pat. No. 5,683,669 to Hartmann et al. thus describes a number of such aluminum chloride generators and their use in the manufacture of chloride process pigmentary titanium dioxide, particularly see columns 3 and 4. As related by Hartmann et al., however, the “extreme exothermic quality” of the reaction between aluminum solids and chlorine whereby the aluminum chloride is generated, brings difficulties in controlling the reaction, in sintering of the aluminum solids, in formation of a damaging alloy between the molten aluminum and the reactor/generator wall, in damage of the reactor wall by corrosion of the gaseous mixture and the high temperatures, and in clogging of the reactor by condensation of aluminum chloride solids on the reactor wall in certain “cold spots”.

Hartmann et al. propose, as a means for countering some of these damaging heat-related consequences as well as to preheat the titanium tetrachloride gaseous stream feeding into the oxidizer, to sweep a titanium tetrachloride stream over the lined inner wall of an aluminum chloride generator for acting as a protective film. Several other references are cited by Hartmann et al. for still other generator arrangements wherein titanium tetrachloride is passed through the generator to remove and utilize some of the heat of formation of the aluminum chloride, and in fact it has become a generally accepted practice to pass all or substantially all of the titanium tetrachloride reactant stream through an aluminum chloride generator for these purposes, as well as for avoiding the complexities of accurately metering in a separate titanium tetrachloride gaseous stream to maintain tight control in the crude titanium dioxide pigment over the amounts of added alumina and other like metal oxide additives.

A significant disadvantage of using aluminum chloride generators according to conventional practice is that, because so much titanium tetrachloride is passed through the generators, the capital cost for making sufficient aluminum chloride for several oxidizer lines can be prohibitive. Consequently those skilled in the art have heretofore been faced with a choice between a first mode of operation that tends to be more operating cost-intensive (in the purchase of aluminum chloride solids and in addressing maintenance issues posed by dealing with mixed aluminum chloride/titanium tetrachloride streams) and a second mode of operation on the other hand that has its own maintenance challenges associated with the exothermicity of aluminum chloride generation and the corrosivity of aluminum chloride/titanium tetrachloride mixtures at generator conditions, but which is much more capital-intensive.

### SUMMARY OF THE PRESENT INVENTION

The present invention provides a better alternative to those skilled in the art from both a maintenance cost and reliability perspective and also a capital cost perspective, in providing according to a first aspect a process for making pigmentary titanium dioxide by the gas phase oxidation of titanium tetrachloride in the presence of aluminum chloride, wherein the aluminum chloride is produced by subliming aluminum chloride solids. In a second aspect, the invention concerns a novel and improved process for subliming aluminum chloride solids which is particularly suited for use in a chloride process for making pigmentary titanium dioxide.

The present invention thus utilizes aluminum chloride solids, but rather than dissolving the same in hot liquid titanium tetrachloride, sublimes the aluminum chloride solids to produce aluminum chloride gases. Aluminum chloride gases from the sublimation step are then combined with titanium tetrachloride gases which have been separately generated for being fed to an oxidizer, the combination preferably occurring just prior to the entry of the titanium tetrachloride gases into the oxidizer and more preferably occurring as close to the entry point of the titanium tetrachloride gases as possible given equipment constraints, obstructions and the like. The combined titanium tetrachloride and aluminum chloride gases are thereafter oxidized in the oxidizer to produce a crude, pigmentary titanium dioxide product.

By avoiding having to dissolve the aluminum chloride solids in the hot liquid titanium tetrachloride and then vaporizing the mixture as has been the practice previously, the titanium tetrachloride vaporizer can be kept clear of the solids that have otherwise been formed due to the nonvolatile impurities in the aluminum chloride solids. Further, by combining sublimed aluminum chloride and the vaporized titanium tetrachloride in a preferred manner, just prior to the titanium tetrachloride's introduction into the oxidizer, the corrosion-related difficulties and costs associated with the handling of a hot, mixed stream of aluminum chloride and titanium tetrachloride gases can be largely avoided.

Parenthetically, direct sublimation has been known and used previously for refining and purifying crude aluminum chloride solids in the context of aluminum manufacture, see, for example, Belgian Patent No. 633119 and U.S. Pat. No. 4,514,373 to Wyndham, but to our knowledge has not been used or suggested for use in generating aluminum chloride gases in the different context of making chloride process titanium dioxide pigments. In regard to the particular devices used, the Wyndham reference describes as conventional the use of a screw conveyor having a heated jacket or screw (or both) for purifying crude aluminum chloride, wherein under constant agitation, at a temperature of not less than 180 degrees Celsius and a pressure not less than atmospheric pressure, aluminum chloride solids are sublimed and the resultant gases purged using nitrogen. A disadvantage of this sort of device for making chloride process titanium dioxide pigments is that an inventory of aluminum chloride solids is always present, making the sublimers difficult to start and stop as quickly as might be desired.

Belgian Patent No. 633119 suggests a flash vaporizing of aluminum chloride powder, using a superheated stream of recycled aluminum chloride gases to produce a low temperature stream of sublimed aluminum chloride. A disadvantage of the proposed process and apparatus for our purposes is that an impractically high proportion (about one half) of the aluminum chloride gases generated by sublimation must be recompressed, superheated and recycled to enable a particular net production of aluminum chloride gases for subsequent use.

The process provided by the present invention for subliming aluminum chloride solids fundamentally involves combining the aluminum chloride solids with inert, preferably highly thermally conductive solids for improved heat transfer to the aluminum chloride solids to be sublimed. Inert gases are supplied to the vessel at a flowrate at least sufficient with the flow of generated aluminum chloride gases from sublimation to fluidize the aluminum chloride solids and inert solids, and the aluminum chloride solids are heated and sublimed by means of heat provided through the inert gases and/or through the vessel walls and transferred at least in part through the inert, thermally conductive solids.

Beyond their thermal conductivity, the inert solids are preferably also characterized as of a type of material that could be carried into the oxidizer and into the desired pigmentary titanium dioxide product without unduly complicating conventional downstream processes or compromising pigment quality—by way of nonlimiting example, a scour medium such as alumina or sand which is conventionally removed from the process or perhaps a pelletized or sintered titanium dioxide material that can remain with the product through finishing of the pigment.

With the use of the inert solids to improve heat transfer and thus the efficiency with which the aluminum chloride solids are sublimed, and with the supplied gas flow being preferably just that required with the sublimation gases to properly fluidize the bed of aluminum chloride and inert solids, the sublimer can be much smaller and much less capital-intensive for the same flow of aluminum chloride gases than either a conventional aluminum chloride generator or a sublimer according to Belgian Patent No. 633119- and the aluminum chloride solids in the sublimer can be rapidly vaporized and the sublimation gases removed from the sublimer so that very little if any aluminum chloride inventory is left in the sublimer to cause difficulties, should a fast shutdown of the sublimer be necessary.

### DETAILED DESCRIPTION OF PREFERRED EMBODIMENTS

A preferred embodiment of a process of the present invention for making pigmentary titanium dioxide involves oxidizing titanium tetrachloride in the gas phase in the presence of aluminum chloride gases, to produce a crude titanium dioxide product having alumina incorporated into its crystalline lattice (so-called “burned-in alumina”), as part of a chloride process for making a rutile titanium dioxide pigment such as commonly used in paper, in plastics and in coatings of various types. The chloride process for making rutile titanium dioxide pigments need not be described in any detail herein, as the general process is well-known and described in many references and as the details of the chlorination, oxidizing and finishing operations involved in such a process are not affected by the present invention. The incorporation of alumina in the oxidizing step is also well-known as described above, the contribution of the present invention being found in the manner in which the aluminum chloride gases are supplied for being oxidized with the titanium tetrachloride gases in the oxidizer. Namely, the aluminum chloride gases are supplied in the present invention by subliming aluminum chloride solids and then combining aluminum chloride gases from the sublimation step with titanium tetrachloride gases, the combination preferably occurring just prior to the oxidizer and more preferably occurring as close to the entry point of the titanium tetrachloride gases into the oxidizer as possible given equipment constraints, obstructions and the like, so that in turn the corrosive mixture of aluminum chloride and titanium tetrachloride gases is encountered as little as possible in the process equipment.

The aluminum chloride solids in this case will typically be purchased, rather than being generated through the carbo-chlorination of aluminum-bearing ores and the eventual condensation of aluminum chloride solids as practiced in the making of aluminum metal. Usually purchasing the aluminum chloride solids will prove to be more economical on the whole, however, it is by no means excluded that the solids might be generated and conceivably stored onsite to be used when needed.

In any event, the aluminum chloride solids are combined with one or more inert, thermally conductive solids in a vessel, and one or more inert gases are supplied to the vessel at flowrates at least sufficient with the flow of aluminum chloride sublimation gases to maintain the combined aluminum chloride solids and inert, thermally conductive solids in a fluidized condition. Heat is supplied through heating the vessel and/or through heating the inert gases for causing aluminum chloride solids in the fluid bed to sublime, and the heat transfer to the aluminum chloride solids for such purpose is aided and accomplished at least in part by means of the inert, preferably highly thermally conductive solids employed in the fluid bed with the aluminum chloride solids. To avoid the capital issues associated with the use of aluminum chloride generators such as described by Hartmann et al., in which all of substantially all of the titanium tetrachloride gases in question have been passed through the generators, preferably in our sublimer the inert gas flowrates will not greatly exceed the minimum required flowrate for keeping the inert and aluminum chloride solids fluidized—preferably being not more than 200 percent of that required with the flow of sublimed aluminum chloride gases to achieve fluidization of the combined hot, inert solids and aluminum chloride solids.

Suitable inert gases may be, for example, nitrogen or carbon dioxide—both of which, of course, are found in the gas products stream from the oxidizer in the normal course of operations. In contrast to the known aluminum chloride generators involving large flows of titanium tetrachloride gases, the inert gas flow requirement for the sublimer of our invention can be as little as 1 to 2 percent by volume of the total oxidizer flow; consequently, the inventive sublimer can advantageously—for both capital and space reasons—be sized much smaller for the same production of aluminum chloride gases, as compared to a conventional aluminum chloride generator. In addition, the corrosion issues associated with the mixing of the aluminum chloride sublimation gases and titanium tetrachloride gases can be minimized as the gases are combined just prior to the oxidizer.

The inert, thermally conductive solids are present to aid in heat transfer from heated vessel walls and/or from hot inert gases supplied to the vessel to the aluminum chloride solids to be sublimed. Preferably too, beyond being inert and thermally conductive in the application, the inert solids will be selected to be of a type of material that could be carried into the oxidizer and into the desired pigmentary titanium dioxide product without unduly complicating conventional downstream processes or compromising pigment quality—by way of nonlimiting example, a scour medium such as alumina or sand which is conventionally removed from the process or perhaps a pelletized or sintered titanium dioxide material that can remain with the product through finishing of the pigment—while at the same time preferably having a thermal conductivity at least about equal to that of silica sand (thermal conductivity of between 3 and 4 btu/hr-ft-deg F. at 600 degrees Fahrenheit). Suitable inert solids are described, for example, in U.S. Pat. No. 6,419,893 to Yuill et al., United States Patent Application Publication No. 2005/0249651 to Flynn et al., U.S. Pat. No. 5,544,817 to Brownbridge et al., U.S. Pat. No. 6,036,999 to Zhao et al, and United States Patent Application Publications Nos. 2004/0187392 and 2004/0239012 to Krause et al.

While the novel aluminum chloride sublimer described and claimed herein is especially useful for providing aluminum chloride gases to be combined with titanium tetrachloride gases for being subsequently oxidized in the oxidizer of a chloride TiO2 process, those skilled in the art will also appreciate that the sublimer can be used in other contexts wherein the sublimation of aluminum chloride solids generally has already been known and practiced (e.g., in aluminum manufacture per the U.S. Pat. No. 4,514,373 to Wyndham or Belgian Patent No. 633119 references mentioned above), but further in either a chloride or sulfate process (for producing pigmentary titanium dioxide) for providing an alumina post-treatment of a crude, chloride- or sulfate-process pigmentary titanium dioxide. Those skilled in the art may readily conceive of still other alterations to, variations of and equivalents to the specific embodiments of the invention described herein but which should properly be considered as within the scope of our inventive contributions. Accordingly, the scope of the present invention should be assessed as that of the appended claims and by equivalents thereto.

What is claimed is:

1. A process for making pigmentary titanium dioxide through the oxidation of titanium tetrachloride in the presence of aluminum chloride, comprising the steps of:
a. subliming aluminum chloride solids to form aluminum chloride gases;
b. combining aluminum chloride gases from the sublimation step with titanium tetrachloride gases; and
c. oxidizing the combined aluminum chloride and titanium tetrachloride gases.

2. A process as defined in claim 1, wherein the aluminum chloride and titanium tetrachloride gases are combined just prior to being introduced into the oxidation reactor wherein the aluminum chloride and titanium tetrachloride are oxidized.

3. A process as defined in claim 1, wherein the aluminum chloride solids are sublimed at least in part by conductive heat transfer from hot, inert solids contacting the aluminum chloride solids.

4. A process as defined in claim 3, wherein the hot, inert solids and aluminum chloride solids are fluidized together in a heated, fluidized bed sublimer, by a supply of one or more inert gases sufficient with the flow of sublimed aluminum chloride gases to fluidize the combined hot, inert solids and aluminum chloride solids to be sublimed.

5. A process as defined in claim 4, wherein the supply of one or more inert gases is determined by determining how much additional gas flow is needed beyond the flow of sublimed aluminum gases to fluidize the combined hot, inert solids and aluminum chloride solids to be sublimed.

6. A process as defined in claim 5, wherein the supply of one or more inert gases is not more than 200 percent in excess of that required with the flow of sublimed aluminum chloride gases to achieve fluidization of the combined hot, inert solids and aluminum chloride solids.

7. A process as defined in claim 3, wherein the hot, inert solids are selected from those materials which have been judged suitable for adding to an oxidizer for oxidizing titanium tetrachloride to produce a crude pigmentary titanium dioxide.

8. A process as defined in claim 7, wherein the hot, inert solids include pelletized titanium dioxide solids.

9. A process as defined in claim 7, wherein the hot, inert solids include a scouring medium for removing solids deposits from an interior surface of the oxidizer.

10. A process as defined in claim 9, wherein the hot, inert solids include an alumina, zirconium silicate, silica sand or calcined or sintered titanium dioxide scouring medium.

11. A process for subliming aluminum chloride solids, comprising combining aluminum chloride solids to be sublimed in a vessel with inert, thermally conductive solids, supplying one or more inert gases to the vessel at flowrates sufficient with the flow of aluminum chloride sublimation gases to maintain the combined aluminum chloride and inert, thermally conductive solids in a fluidized condition, and applying sufficient heat through one or more of the vessel, the inert, thermally conductive solids and the one or more inert gases to cause the sublimation of aluminum chloride solids in the vessel.

12. A process as defined in claim 11, wherein inert solids are employed having a thermal conductivity at least about equal to that of silica sand.

13. A process as defined in claim 11, wherein the inert, thermally conductive solids include one or more of alumina, silica sand, zirconium silicate and calcined and sintered titanium dioxide.
